(19) United States
(12) Patent Application Publication
(10) Pub. No.: US 2005/0169187 A1
(43) Pub. Date: Aug. 4, 2005

(54) Methods and apparatus for testing automatic path protection switching

(76) Inventors: Richard Taylor, Edinburgh (GB); Gilbert Jamieson, Seafield (GB); Nicholas W. Gent, Dalkeith (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/767,865

(22) Filed: Jan. 30, 2004

(51) Int. Cl. H04L 12/26

(52) U.S. Cl. 370/248

(57) ABSTRACT

Automatic path protection switching in a synchronous optical network is tested by reference to test messages carried in section trace (J0), path trace (J1) and/or lower-order path trace (J2) sequences.

This invention relates to methods and apparatus for testing automatic path protection switching (APPS) in synchronous optical networks, such as networks conforming to the US SONET or European Synchronous Digital Hierarchy (SDH) standards.

### BACKGROUND ART

Automatic Protection Switching (APS) is used in telecommunications networks to maintain logical connections within the network even if a physical connection (e.g. a specific optical link) is damaged. When the physical connection malfunctions the network senses the problem and uses redundant capacity on other physical connections to re-route the traffic around the disruption. The speed and accuracy of implementing this re-routing is one of the critical measures for a telecommunications switch. One traditional solution is to have a dedicated ‘protection’ optical fibre associated with every ‘working’ fibre. Then if there is a disruption to the signal on the ‘working’ fibre the entire signal traffic traversing that fibre is switched over to the protection fibre. However, this is very wasteful because it implies that the network can utilise at most 50% of its fibre capacity, or, put another way, that each bit transferred by the network costs twice as much as it otherwise would.

In order to improve the utilisation of the network infrastructure, the network equipment manufacturers are now beginning to implement Automatic Path Protection Switching (APPS). In APPS if the ‘working’ fibre is degraded then individual SONET/SDH paths (or channels) whose signals were being multiplexed over that fibre are independently re-routed around the problem. There is no guarantee that any two paths that were on the same physical link before the degradation will be rerouted using the same, new physical route. This now method of protection switching imposes a significantly greater design complexity and performance load on a telecommunications switch.

APPS also makes the testing of protection switching significantly more difficult. Previously the whole link and all the paths it was carrying were switched as one item, and therefore it was sufficient to test a single path and assume that the results would apply to all the other paths carried with it. Additionally traditional APS takes no account of the structure of the SONET/SDH signal (i.e. the allocation of resources amongst different paths), so there was no need to test APS with varied channel/path structures within the SONET/SDH signal. However, with APPS it is now necessary to look at each path individually because no single path can be assumed to be representative of the other paths carried by the fibre under test. Furthermore, the specific details of the channel/path structure within the signal are now crucial because it is those paths that are being individually switched. So the complexity of testing APPS is a compound one: not only must each of as many as 5376 VT channels/paths per port be tested (for OC-192/STM64 signals), but the test must be repeated multiple times with different structures.

### DISCLOSURE OF INVENTION

According to one aspect of this invention there is provided a method of testing automatic path protection switching (APPS) in a synchronous optical network, comprising:
defining test message data;
incorporating the test message data into a sequence of trace octets embedded in synchronous optical data frames, said trace octets comprising at least one of section trace (J0), path trace (J1) and lower-order path trace (J2) sequences;
transmitting the synchronous optical data frames over a synchronous optical path to be tested;
receiving the synchronous optical data frames after they have traversed the synchronous optical path;
extracting the incorporated test message data; and
comparing the extracted test message data with the defined test message data to test automatic path protection switching of the synchronous optical path.

The invention thus provides a way of confirming that connectivity (the logical path) has been maintained after the APPS has occurred. An individual path can be identified in SONET/SDH systems by a user-definable message of either 16 or 64 bytes that can be carried by the ‘J1’ octet defined as part of the ‘path overhead’ portion of a SONET/SDH frame. The inventor has recognised that this capability can be used to obtain confirmation that a particular path is being received correctly during APPS, by determining whether the message received for that path is the expected message. Similar use can be made of the J0 section trace and J2 lower-order path trace octets.

According to another aspect of this invention there is provided apparatus for testing automatic path protection switching in a synchronous optical network, comprising:
a message definer for defining test message data and incorporating the test message data into a sequence of trace octets embedded in synchronous optical data frames, said trace octets comprising a selected one of section trace, path trace and lower-order path trace sequences;
a transmitter for transmitting the synchronous optical data frames over a synchronous optical path to be tested;
a receiver for receiving the synchronous optical data frames after they have traversed the synchronous optical path; and
a comparator for extracting the incorporated test message data and comparing the extracted test message data with the defined test message data to test automatic path protection switching of the synchronous optical path.

### BRIEF DESCRIPTION OF DRAWINGS

A method and apparatus in accordance with this invention, for testing automatic path protection switching, will now be described, by way of example, with reference to the accompanying drawings, in which:

FIG. 1 is a simplified schematic diagram of apparatus for implementing the invention;

FIGS. 2 and 3 are flow diagrams of procedures implemented in the apparatus of FIG. 1;

FIG. 4 shows the structure of a SONET STS-1 data frame; and

FIG. 5 shows an example of a display of results of a test of signal path integrity.

### DETAILED DESCRIPTION

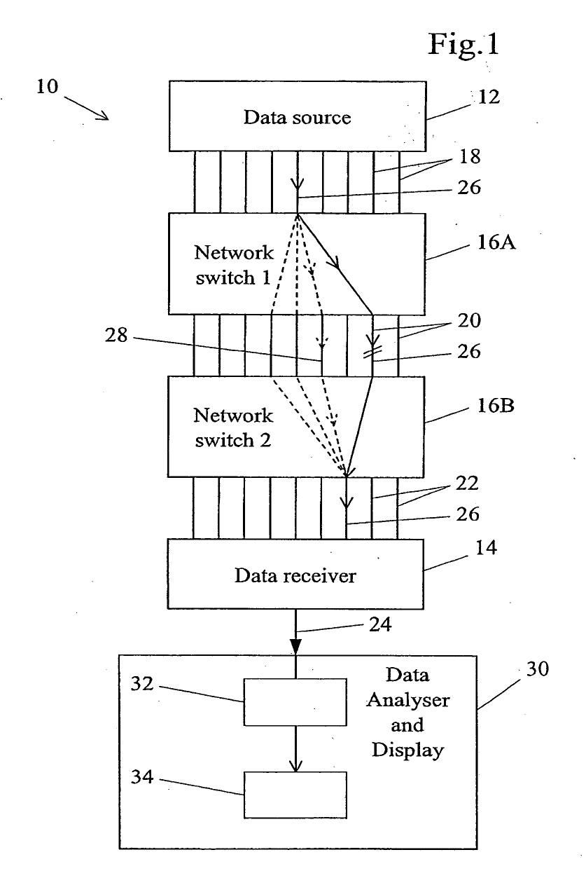

FIG. 1 shows a simplified schematic diagram of apparatus 10 for implementing the invention. The apparatus includes a data source 12 that is connected to a data receiver 14 via network switches 16A, 16B forming part of a SONET or SDH network. A number of possible virtual channels 18, 20, 22 connect the switches 16A and 16B to the data source 12 and data receiver 14.

The data receiver 14 provides an output 24 of a particular data path received from the source 12. If one virtual channel 26 carrying that particular data path becomes cut or degraded, then protection switching will create a new virtual channel 28.

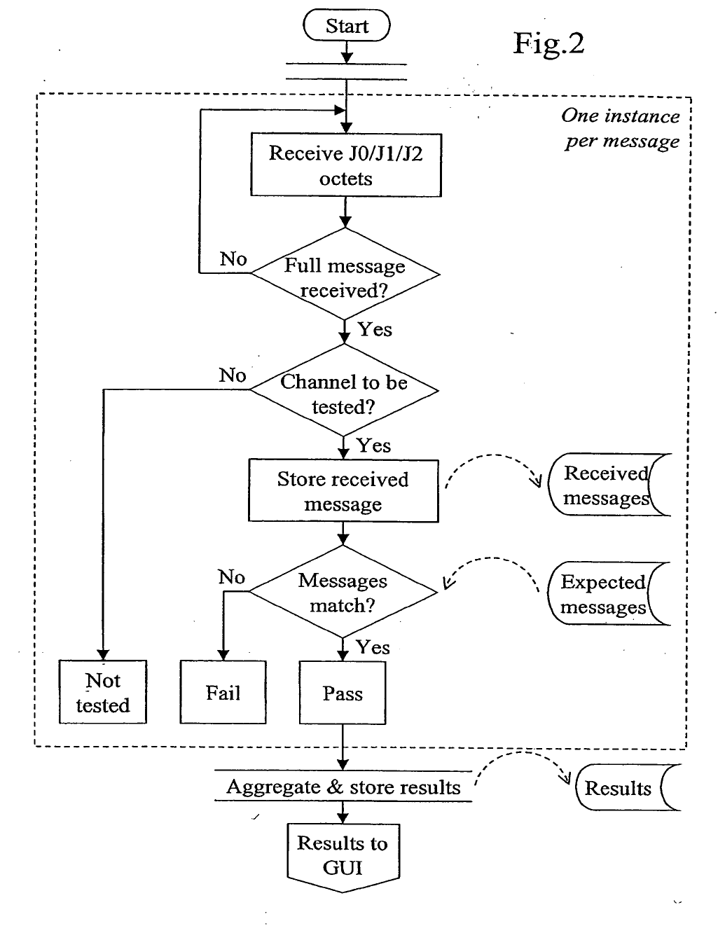

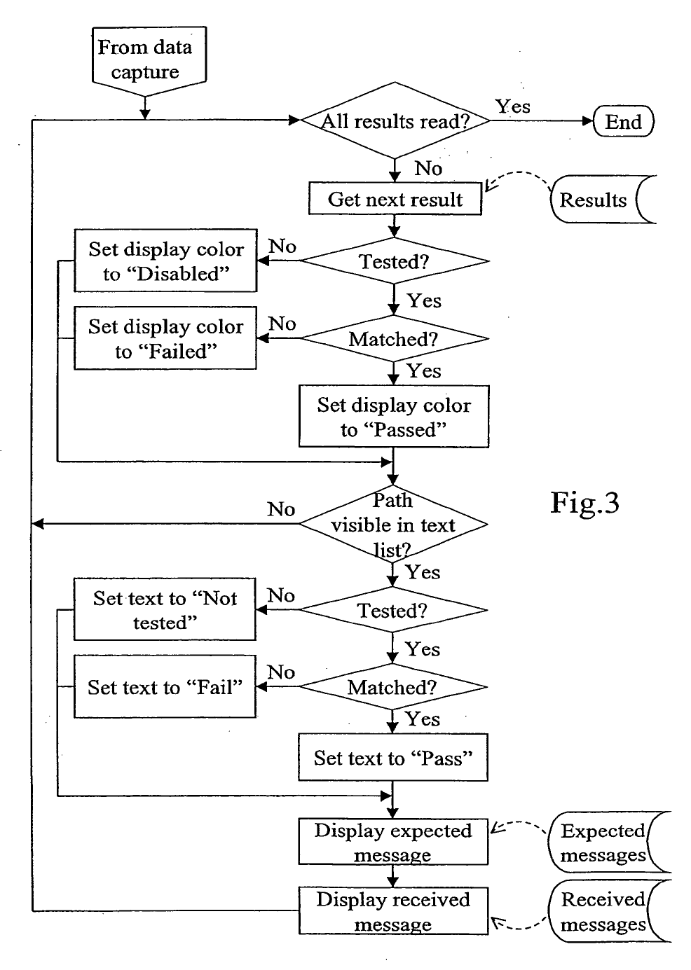

A data analyzer 30 connected to the data output 24 is configured to perform the method of the invention. In outline, an error detector 32 comprising an appropriately- programmed microprocessor or application specific devices is configured to carry out the steps in the flow diagrams of FIGS. 2 and 3 to generate error decision outputs (FIG. 2) and control a graphical user interface display 34 (FIG. 3) to provide information on the test results to a user.

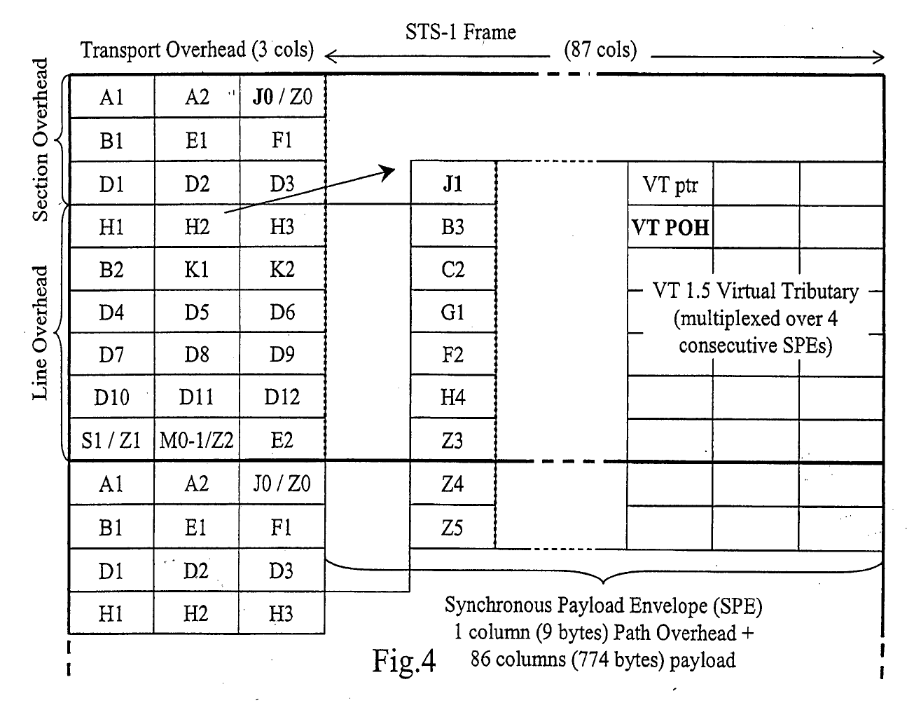

To assist in confirming whether an individual data path has been correctly switched by the APPS system, the invention makes use of the J0, J1 and J2 octets provided by the SONET and SDH specifications. FIG. 4 shows, by way of example, the structure of a SONET STS-1 data frame, including the J0 and J1 octets and the location occupied by the J2 octet when present. Referring to FIG. 4, an STS-1 frame comprises 810 octets, notionally organised as ninety columns of nine octets each. The first three columns comprise the section overhead (the first three octets of each column) and the line overhead (the remaining six octets in each column). The section overhead includes an octet designated as J0 (the first octet of the third column) that is used to transmit an identifier to enable a network section receiver to verify its continued connection to the intended transmitter at the other end of a SONET network section.

The remaining 87 columns of the frame are used to carry the payload data, in the so- called Synchronous Payload Envelope (SPE). There is no fixed positional relationship between the first octet of the SPE and the first octet of the 4^{th} column of the frame, i.e. the SPE can start anywhere within the 87 columns for payload data, at a location specified by H1 and H2 pointers in the line overhead. The first column of the SPE is designated as the path overhead, and the first octet of this overhead is defined as the J1 octet, used to enable the receiving terminal in a path to verify its continued connection to the intended transmitting terminal.

One particular use of STS-1 frames is for transmission of DS1 telecommunications signals (e.g. voice calls), in Virtual Tributary frame structures. For example, a defined VT1.5 frame consists of 27 octets, structured as 3 columns of 9 octets each. At a SONET frame rate of 8000 frames per second these octets provide a transport capacity of 1.728 Mbit/s, and thus accommodate a 1.544 Mbit/s DS1 signal. Typically 28 VT1.5 frames are multiplexed into a SONET STS-1 frame structure, occupying 84 of the 86 available columns of the SPE. The VT frame structure is multiplexed over four consecutive STS-1 SPEs. Four VT path overhead (VT POH) octets are provided, one in each of the four consecutive SPEs. The VT path overhead octet in the second of these SPEs is designated as the J2 octet, used to support end-to-end monitoring of a path.

The invention uses the J0, J1 and/or J2 octets to carry test messages identifying the transmitter port and SONET channel over which data in a particular path are being transmitted. At the data receiver 14 these octets are extracted and reassembled to recover the test messages, which are then compared with the test messages as transmitted by the data source 12 (defined as described below) to confirm whether a path between specific transmitter and receiver ports is still intact (i.e. has not been affected by any path switching or has been properly protected by APPS).

A practical aspect of implementing the invention is that there are typically several thousand J0/J1/J2 messages to configure, receive, and compare per port to be tested (e.g. 1344 J2s, 48 J1s and 1 J0 for OC-48, and four times as many J2s and J1s for OC-192). Theoretically this could be done manually, but the time required is in practice prohibitive. A maximum typing speed is considered to be around five characters per second and there are up to 23,198 editable characters per port for OC-48 and 92,606 per port for OC-192. It would take at least five hours of non-stop, error-free typing merely to enter the many tens of thousands of characters required for a single port. In addition time is required to run the test, recover the results, and compare the received messages against the expected values.

The data source 12 therefore accepts and implements special commands that can generate the required J0/J1/J2 messages, in which the source 12 automatically embeds unique information to identify the port and channel over which a path is being carried. This allows a single template message to be applied to all channels on all ports which will result in an individual, uniquely identifiable message being transmitted over each path. This dramatically increases the speed of configuration of the transmitted messages.

The command for generating J0/J1/J2 messages may include user-defined fixed character strings and escape sequences to generate variable character strings:
User defined character string. Can be up to (and including) 15 or 62 bytes long depending on the current selected setting of J0/J1 trace mode (J2 messages can be only 15 bytes long). The appropriate terminator (e.g. CRC or <cr><lf>) is added. For methods that set the Path Trace Message (Tx and expected Rx) the string may contain escape sequences which will be replaced with variable text before the Trace message is used. These escape sequences can appear anywhere in the message (multiple times if desired). They are all fixed width and the escape sequence reflects the number of characters that the field takes. Examples of escape sequences are:
   <inst>—Replaced with the instrument number (6 characters, taken from configured name).
   <port>—Replaced with the port number (6 characters in the format nnnn/n, which is made up of the rack position, module number and the physical port within the module).
   <c>—Replaced with the channel number (3 digits, leading 0 added if needed).
   <1>—Replaced with the lower-order path number (3 digits, leading 0 added if needed).

### J0 EXAMPLE

As defined by user: “Agilent OmniBER XM<inst>, Port <port>”
As transmitted for testing: “Agilent OmniBER XM J7245A, Port 6501/2”

### J1 EXAMPLE

As defined by user: “Agilent OmniBER XM<inst>, Port <port>, HO-Path <c>”
As transmitted for testing: “Agilent OmniBER XM J7241A, Port 6603/1, HO-Path 001”
   “Agilent OmniBER XM J7241A, Port 6603/1, HO-Path 002”. . . through to . . .
   “Agilent OmniBER XM J7241A, Port 6603/1, HO-Path 191”
   “Agilent OmniBER XM J7241A, Port 6603/1, HO-Path 192”
      (Depending on rate and configuration—example is OC-192 configured as all STS-1's)

### J2 EXAMPLE

### 15 Bytes Only Editable

As defined by user: “A<port>-<c>-<1>”
As transmitted for testing: “A6501/2-001-011”
   “A6501/2-001-012”
   . . . through to . . .
   “A6501/2-192-073”
   “A6501/2-192-074”
      (Depending on rate and configuration—example is OC-192 configured as all STS-1's, containing all VT1.5's)

The system also enables the expected messages used for comparison in the data receiver 14 to be automatically configured in any of three ways:
(i) J0/J1/J2 messages being received are captured and stored, and then treated as reference values for comparison with subsequently received messages;
(ii) messages are setup for transmission by the user; the content of the messages can be specified in its entirety, or the user can edit the content of messages previously received and then store the modified messages for use as expected values;
(iii) messages being transmitted from any selected port can be captured and stored for use as reference values for comparison with messages subsequently received.

The time taken to recover received J0/J1/J2 messages is a particular factor than can adversely affect the validity of the results obtained. APS and APPS are dynamic systems, so it is entirely possible for another protection switch operation to occur, or for paths to revert to their working link after a period of resumed error-free transmission. This can easily give false test results if a change has occurred during an extended results-gathering phase. Even carrying out this process with an automated remote control system connected to the test equipment only partially helps. While this would speed up the test the results still have to be measured sequentially, and hence the results at the start of the test period could relate to a different network situation from results gathered at the end.

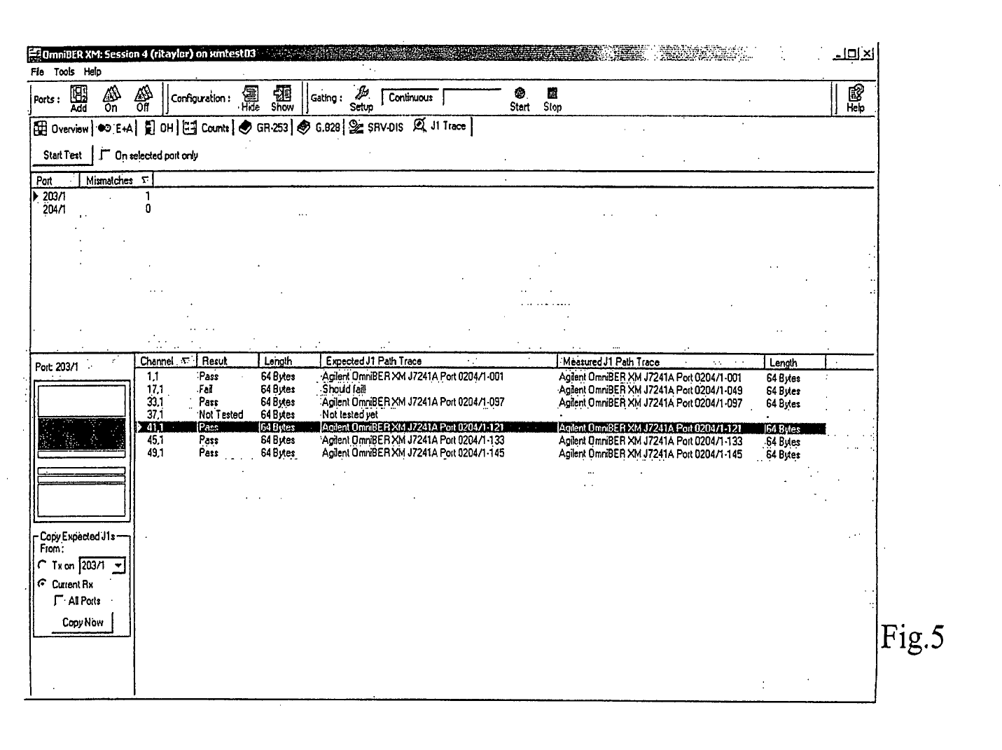

The data receiver 14 is arranged to capture the J0/J1/J2 messages from all ports in parallel and to cache these results for analysis, so that the result of the test is unaffected by any later changes in the network. The results are correlated and displayed both graphically and as a list in order to facilitate quick inspection of the results by a user, as illustrated by the example in FIG. 5. In this example the path carried via port 203/1 has encountered a mismatch between the received and expected path trace message carried by the J1 octets for channel 17/1: the expected message is “Should fail!”, whereas the actual message received is “Agilent OmniBER XM J7241A Port 0204/1-049”—the expected message text has been imposed for demonstration purposes to simulate the effect of an APPS failure.

Thus the practical problems that obstruct effective testing of APPS are overcome: the process of configuring the data source 12 is accelerated; the process of configuring the expected results for comparison is accelerated; the possibility of human error, when comparing thousands of messages which may differ in only 1 character, is removed; and the results are frozen in time such that the time interval required to analyse and inspect the results does not compromise those results.

1. A method of testing automatic path protection switching in a synchronous optical network, comprising:
defining test message data;
incorporating the test message data into a sequence of trace octets embedded in synchronous optical data frames, said trace octets comprising at least one of section trace, path trace and lower-order path trace sequences;
transmitting the synchronous optical data frames over a synchronous optical path to be tested;
receiving the synchronous optical data frames after they have traversed the synchronous optical path;
extracting the incorporated test message data; and
comparing the extracted test message data with the defined test message data to test automatic path protection switching of the synchronous optical path.

2. The method of claim 1, wherein the step of defining test message data comprises adopting data inserted by user applications in the trace octets as the test message data.

3. The method of claim 1, wherein the step of defining test message data comprises receiving trace messages incorporated in synchronous optical data frames and editing the received trace messages to define the test message data.

4. Apparatus for testing automatic path protection switching in a synchronous optical network, comprising:
a message definer for defining test message data and incorporating the test message data into a sequence of trace octets embedded in synchronous optical data frames, said trace octets comprising a selected one of section trace, path trace and lower-order path trace sequences;
a transmitter for transmitting the synchronous optical data frames over a synchronous optical path to be tested;
a receiver for receiving the synchronous optical data frames after they have traversed the synchronous optical path; and
a comparator for extracting the incorporated test message data and comparing the extracted test message data with the defined test message data to test automatic path protection switching of the synchronous optical path.
